(19) United States
(12) Patent Application Publication
(10) Pub. No.: US 2012/0100428 A1
(43) Pub. Date: Apr. 26, 2012

(54) Particles Coated with an Organically Modified (Hetero)Silicic Acid Polycondensate and Containing a Metal Core Suited for Storing Hydrogen, Batteries Produced Therewith, and Method for the Production Thereof Using the Particles

(75) Inventors: Michael Popall, Wuerzburg (DE); Birke-Elisabeth Olsowski, Veitshoechheim (DE); Sebastien Cochet, Oberhausen (DE)

(73) Assignee: Fraunhofer-Gesellschaft zur Foederung der angewand ten Forschung e.V., Muenchen (DE)

(21) Appl. No.: 13/381,453

(22) PCT Filed: Jun. 29, 2010
(86) PCT No.: PCT/EP10/59207

§ 371 Date: Dec. 29, 2011

(30) Foreign Application Priority Data
Jun. 30, 2009 (DE) 10 2009 030 994.2
Aug. 11, 2009 (DE) 10 2009 036 945.7

(51) Int. Cl. H01M 4/58

(52) U.S. Cl. 429/218.2; 29/623.5

(57) ABSTRACT

The present invention relates to particles, which are suited as electrode material for the negative electrode of a battery functioning according to the principle of nickel-metal hydride batteries. In order to increase the power density of such batteries, it is desirable to use relatively small particles for the electrode material. However, said particles are sensitive to air and frequently highly flammable. The invention therefore proposes to provide said particles with a coating made of an organically modified (hetero) silicic acid polycondensate. In the presence of the KOH electrolyte solution, said coating converts during operation into a gel electrolyte, which not only does not impede the passage of the ions necessary for the activity of the battery, but even facilitates it.

This invention refers to powder made of or containing particles that have a metal core suitable for hydrogen storage and a preferably fully enveloping coating for this core made of or containing an organically modified (hetero) silicic acid polycondensate. The invention also refers to an electrode that contains or is made of such powder, alone or combined/mixed with additional constituents, and a battery whose negative electrode contains hydrogen-storing metal particles in a gel-shaped matrix that conducts OH⁻ions.

In the course of “green electronics”, nickel-metal hydride (NiMH) batteries have been developed for replacing NiCd batteries that no longer contain poisonous heavy metals. However, they have not yet fully replaced NICd batteries because their higher energy density is countered by lower cycle durability and especially a lower maximum charging and discharging current. For this reason, applications needing high energy consumption such as cordless power tools, emergency current aggregates and various mobile medical technology applications, etc. still need NiCd batteries.

The negative electrode of a rechargeable battery that works according to the NiMH battery principle consists of a metal alloy able to store hydrogen atoms in its crystal lattice that frequently contains nickel and/or the composition AB₅ or AB₂, although this is not a necessity. During the charging process, the crystal lattice of these electrodes absorbs hydrogen, forming a metal hydride. When energy is retrieved, the hydrogen diffuses more or less quickly out of the interior of the electrode material to the surface, where it reacts with the OH⁻ions of the electrolyte (generally a 20% KOH solution). In this case, the negative electrode is the component that determines the speed of such a rechargeable battery. The larger the surface and the shorter the diffusion paths to the surface, the faster will the energy be released and the higher will also be the currents that can be withdrawn. Thus, the power density of the NiMH battery depends on the available surface.

The electrode's geometric surface can be enlarged, for example, with even thinner electrodes, but it is more effective to reduce the particle size of the metal powder because this allows the surface to volume ratio to be enlarged even further. In the NiMH rechargeable batteries commonly available in the market, particle size is in the order of some ten micrometers. Thanks to innovative milling techniques, it is possible to obtain particle diameters of only a few micrometers, which significantly increases the surface of mixed metal particles. Various methods can be employed to attain such particle size reduction: The Mechanomade® method (MBN Nanomaterialia, Vascon di Carbonera (Italy), www.mbn.it, a highly energetic ball milling process that can be carried out in an inert or reactive atmosphere that produces microparticles. In addition, a nanocrystalline structure is also obtained that leads to considerably more hydrogen release per unit of time.

Another method is Mechanofusion® (Hosokawa Micron Ltd., Runcom (UK), www.hosokawa.co.uk), which facilitates the production of new metal alloys through mechanical-chemical reactions between 2 (or more) materials. This method improves particle properties through the local melting of microparticles.

Owing to the significantly higher surface energy, a fine crystalline mixed metal powder has a decisive disadvantage, however: Its high flammability when exposed to air. The task of this invention is therefore to eliminate this problematic reactivity for the production of battery cells.

To solve this task, it is suggested to initially passivate the metal powder before processing.

As a kind of corrosion protection, the passivation coating should prevent the oxidation of the mixed metal alloy during battery production. In spite of this passivation coating, however, the surface of the mixed metal particles must be accessible for the electrolytes but not hinder the ion access of the battery electrolytes to the particles. These are two requirements that a material cannot really fulfill simultaneously.

We were able to determine totally unexpectedly that a passivation coating made from an organically modified (hetero) silicic acid polycondensate adheres very well to the powder particles (such as nickel mixed metal particles, for example) and therefore provides, on the one hand, protection against environmental influences until the time of inclusion into the anode material and cycling of the NiMH battery produced with this method and, on the other hand, it does not impede—and even facilitates—the flow of hydrogen and other ions to and from the anode into the remaining parts of the battery. It has been a surprising discovery that after the inorganic-organic passivation layer has been processed in the aqueous, alkaline surroundings of the electrolyte (aqueous KOH), it undergoes a change. By absorbing aqueous electrolyte solution, a gel-like material generally forms from it that not only does not impede the passage of the ions necessary for the battery's activity but even facilitates it against all expectations. Like some type of matrix, the material envelops the particles, thus representing a gel-like electrolyte. This electrolyte-gel/medium makes the high discharging speeds possible that are favorable for high-performance applications.

Owing to ion conductivity of the matrix being formed, the thickness of the passivation coating is generally not critical; it is most of the time less than 1 μm, more preferred between 25 and 500 nm, and especially preferred between about 40 and 250 nm.

The organically modified (hetero) silicic acid polycondensate forms an inorganic-organic hybrid polymer layer with a structure of interlinked oligomeres or functional inorganic clusters having often a magnitude from 1 to 10 nm and made of hydrolyzed and condensed silanes that have organic residues as well as, if necessary, metal compounds condensed into the inorganic network. To produce this layer, a coating material made from the corresponding monomeric or oligomeric starting materials can be synthesized with the help of sol-gel chemistry and solidified/hardened after application on the particles. This can take place through subsequent drying, in which case further S—O—Si— or Si—O-metal bonds are generally formed until a large network is created. Then, either additionally or alternatively, when the organic components of the starting materials are ready to undergo a polymerization reaction and an organic network has been built so that the inorganic network made up of Si—O—Si or Si—O-metal bonds is superimposed or penetrated by the organic network. The result: Highly cross-linked, mostly transparent materials whose properties can be selectively adjusted across a wide range by selecting the inorganic and organic structural elements.

Accordingly, the invention makes particles with a metallic core available that is capable of storing hydrogen and that has a coating made from an organically modified (hetero) silicic acid polycondensate. The particles are generally available in the form of a preferred powder that can be poured.

The metallic materials suitable for the invention include nickel and all nickel alloys capable of storing hydrogen, as well as metals such as lanthanum, the lanthanides, manganese, cerium, cobalt, neodymium and/or silicon in suitable form (alloy) inasmuch as they are capable of storing hydrogen in the crystal lattice. Furthermore, alloys of the type AB₅, where A is preferably selected from among the rare earth elements (lanthanides) Ce, Pr, Nd, Pm, Sm, Eu, Gd, Tb, Dy, Ho, Er, Tm, Yb and Lu—possibly mixed with other metals—as they occur in nature (Si, for example) and preferably in a mixture containing one or two of the metals La, Ce and Ti or all these three metals, while B is selected from among Ni, Co, Mn and Al. The materials that contain lanthanum or nickel and the alloys of this type containing lanthanum and nickel are especially preferred, for example LaNi₅, LaNi_{3,9}Co_{0,4}Al_{0,4}Mn_{0,3},LaNi_{3,6}Co_{0,7}Al_{0,4}Mn_{0,3} (Varta's standard AB₅ materials) or La_{0,8}Nd_{0,2}Ni_{2,5}Co_{2,4}Si_{0,1}. Alloys of type AB₂ are also suitable for the invention. Such materials serve as basis for multi-component alloys. In this type, A has been selected from among vanadium and titanium, B especially from among Zr and Ni, but also from Cr, Co, Mn and Fe and mixtures of any of the six mentioned metals, especially Cr+Co+Mn+Fe. It should be clear, however, that the invention is not restricted to these somewhat relatively common, partially rare materials, but that it comprises all hydrogen-storing metals, mixed metals and alloys. Included are, for example, all promising alloys not yet utilized for the NiMH batteries mentioned above but already used for storing hydrogen and partially for thin-film purposes such as magnesium alloys. Examples are alloys of the type MgX where X=Sc, Ti, V or Cr, which can be utilized above all in Mg₄X stoichiometry. Other alloys, in which a high proportion of magnesium (preferably no less than 80 atom %) with a majority of additional main group and/or transition metals is alloyed, preferably selected from among Al, Ni and Mn (example: Mg₈₇Al₇Ni₃Mn₃) are also suitable. If not chipped, the particles generally have average diameters of some tens of pm, frequently 5 to 50 μm; smaller particles are more effective, as mentioned above. With the method indicated above (such as Mechanomade®, for example), particles having sizes of down to 10 μm, sometimes even 1 to 2 μm or still smaller, can be obtained. Hereinafter, they will also be named “nanoparticles”. These are often agglomerates, as results from a measured crystal size of about 50 nm; with known techniques, it is possible to obtain from the agglomerates particles with even smaller diameters that are naturally also suitable for the invention.

Many inorganic-organic hybrid polymers based on a Si—O—Si network are known; a large group of them are the ORMOCER®s, which were developed at the Fraunhofer Institute for Silicate Research. They can also be defined as organopolysiloxanes or hydrolytic condensates of (semi) metal compounds, especially silicon compounds, modified by organic groups (organically polymerizable/polymerized or not polymerizable) bound to the (semi) metal atom. Apart from silicon compounds, other hydrolyzable/hydrolyzed metal compounds (e.g. of aluminum, boron, germanium, etc.) can be provided.

The production of organically modified polysiloxanes or (hetero) silicic acid condensates (frequently also known as “silane resins”) and their properties have been described in a wealth of publications. A representative publication describing hybrid organic-inorganic materials is the MRS Bulletin 26(5), page 364 ff. (2001). Generally speaking, such substances are generally produced using the so-called sol-gel method, wherein hydrolysis-sensitive monomers or pre-condensed silanes are subject to hydrolysis and condensation, if applicable in the presence of additional substances that can be co-condensed such as alkoxides of boron, germanium, zirconium or titanium, and if need be from other compounds that can serve as modifiers or network converters or from other additives such as dyes and fillers. The semi metal or metal cations (M) of the substances that can be co-condensed are incorporated into the Si—O—Si skeleton as heteroatoms, so that Si—O—M and M—O—M bonds can form.

The coating material for the particles according to the invention is preferably manufactured from or uses at least a silane having the formula of (I)

RₐR′_{b}SiX_{4—a—b} (I)

wherein the substituents R, R′ and X can in each case be either the same or different and wherein X represents a group R bound to silicon through carbon, organically cross-linkable or, in rarer cases, already with one or more additional group(s) R, R′ a group bound to silicon through carbon, organically not cross-linkable, X a group that can be hydrolyzed under hydrolysis conditions or split off from silicon or is OH, a is 1 or 2, b is 0 or 1 and a+b can be 1 or 2.

The (mostly subsequent) cross-linking of the group R can take place through one or various groups. “Polymerization” as understood here is, on the one hand, a polyreaction in which reactive double bonds or rings are changed to polymers generally under the influence of heat, light or ionizing radiation (addition polymerization or chain-growth polymerization). Examples for R are therefore groups containing one or more non-aromatic C═C double bonds, preferably with double bonds accessible to a Michael addition such as styryls or (meth)acrylates. For example, a cationic polymerization can take place with an epoxy system (see C.G. Roffey, Photogeneration of Reactive Species for UV Curing, John Wiley & Sons, Ltd. (1997)). Alternatively, the cross-linking can take place through other polyreactions such as ring-opening polymerization. In specific embodiments, this polyreaction can take place directly, e.g. between a group R containing an epoxide on a first silane having the formula (I) and a group R containing an amine on a second silane having the formula (I). Generally, the group R contains at least two and preferably up to about 50 carbon atoms. In this case, through a coupling group, the organically cross-linkable group can be bound directly to the carbon skeleton of the group R, which can be available either as a straight or branched chain. Accordingly, the carbon chain of the group R can be interrupted, if applicable, by 0, S, NH, CONH, COO, NHCOO, NHCONH or the like. Examples of R are acryloxy, methacryloxy, glycidyloxy, allyl, vinyl, styryl or epoxycyclohexyl-C₁—C₄-alkylen residues or those that contain two or more arylate and/or methacrylate groups such as (meth)acrylic acid ester from trimethylolpropane, pentaerythrite, dipentaerythrite, C₂—C₄ alkandioles, polyethylene glycols, polypropylene glycols or possibly substituted and/or alkoxylated bisphenol A that are possibly bound to a silicon-bound alkylene group via a —NCO or —NHCONH group, for example.

It must be emphasized that the groups R that contain one or several acrylate and/or methacrylate groups or rings such as epoxy or epoxy cyclohexyl rings are quite suitable for the invention. Examples for silanes whose group R can already be cross-linked are isocyanates, already trimerized to isocyanurates. These are discrete molecules that have three hydrolytically condensable sylyl residues. The group R′ cannot undergo such a reaction. Preferably, it's possibly a substituted alkyl, aryl, alkylaryl or arylalkyl group whose substituents do not allow cross-linking, in which case the carbon chain of these groups can be interrupted by O, S, NH, CONH, COO, NHCOO, NHCONH or the like. Preferred are non-interrupted groups R′ having 1 to 30 or also up to 50 (more preferred 1 to 5) carbon atoms. The carbon atoms of the group R′ can be substituted or non-substituted.

Group X in formula (I) is one group or OH that can be hydrolyzed or split off the silicon under hydrolysis conditions. The expert knows from the state of the art which groups are suitable for this. Generally, group X is halogen, hydroxy, alkoxy, acyloxy or NR″₂ with R″ equaling hydrogen or a lower alkyl (preferably with 1 to 6 carbon atoms). In some cases, X can also mean hydrogen, but this is generally not desired, as the SiH group can bind directly to the system's organic components (double bonds, for example) and thus affect the system's organic cross-linking, while the residues X in this invention are preferably provided as leaving groups or reaction partners (in the case of OH) during the hydrolytic condensation of the systems. Since alkoxy groups can be split off, they are preferred, especially lower alkoxy groups such as C₁—C₆ alkoxy.

Since the index b can be 0, the silane of formula I can have a group R combined with no group, one group R′ or two groups R in combination with no group or one group R′. In most cases, it is preferred to use at least one silane having the formula (I) with only one group R; it is even more preferred for this silane not to contain any group R′.

If at least an additional silane of the formula (II)

R′ₐSiX₄₋ₐ (II)

is used, the coating material can be produced, wherein R′ and X are in each case the same or different and have the same meaning as in formula (I) and a can be 0, 1, 2, 3 or 4. By adding such silanes with a=0 or 1 to the mixture to be hydrolyzed and condensed, the SiO proportion of the resin (i.e. the inorganic amount) is increased. In formula (II), a=0 or 1 is preferred. Examples for such compounds are tetraethoxysilane and methyl trimethoxysilane or methyltriethoxysilane.

Instead or possibly additionally, the coating material that can be used according to the invention can be produced by using at least one silane having the formula (III)

RₐR′₃₋ₐSiX (III)

wherein R, R′ and X have the previous meaning given for formula (I) and a can be 1, 2 or 3. As a result of this, the organic proportion is increased.

The coating material suitable for the invention can contain additional substances, for example organic compounds of metals of the III main group, from germanium and from metals of the secondary group II, III, IV, V, VI, VII and VIII. These compounds are preferably complexes or chelated compounds, preferably lower (in particular C₁—C₆) metal alkoxides. Another example are organic compounds that can serve as modifiers or cross-linkers (in the latter case, they contain preferably two residues, each one of them can undergo a polyreaction with a group R of the silane of formula (I) and/or (III).

In a specific embodiment of the invention, the coating material is made from or uses at least one silane having the formula (I), in which X does not mean hydroxy and preferably alkoxy and in which a+b preferably equals 1, possibly using at least one additional silane having the formula (II) or (III) and/or a metal compound as described above, together with the one silandiol of formula (IV)

R″₂Si(OH)₂ (IV)

wherein the group R″ is the same or different and is a substituted or unsubstituted alkyl group with preferably 1-12 carbon atoms or means the same as R.

In another specific embodiment of the invention, the silanes of formula (I) can be described by the formula (V) given below:

{XₐR_{b}Si[R′(A)_{c}]_{4-a--b}}ₓB (V)

where

X=halogen, hydroxy, alkoxy, acyloxy, alkylcarbonyl, alkoxycarbonyl or NR″, preferably (C₁—C₄) alkoxy or halogen, e.g. chlorine,

R=alkyl, alkenyl, aryl, alkylaryl, or arylalkyl, especially (C₁—C₄) alkyl

A=O, S, PR″, POR″, NHC(O)O or NHC(O)NR″, especially O or S,

B=straight-chain or branched organic residue with at least one (for c32 1) and

A=NHC(O)O or NHC(O)NR″ and containing at least two C=C double bonds and 5 to 50 carbon atoms,

R″=hydrogen, alkyl or aryl,

a=1, 2 or 3,

b=0, 1 or 2,

c=0 or 1, and

x=an integral number whose maximum corresponds preferably to the number of double bonds in the group R minus 1 or, for c=1 and A =NHC(O)O or NHC(O)NR″, corresponds to the number of double bonds in the group R, preferably=1 or 2. It is especially preferred for the group B to contain at least one or at least 2 C=C double bonds, e.g. acryl and/or methacryl groups.

The coating materials suitable for this invention are, for example, the resins/condensates described in EP 451709 A2, EP 644908 B1, EP 1196478 B1 or EP 1453886 B1, among others.

The coating material is generally produced with the help of the so-called sol-gel method from the monomeric or oligomeric metal compounds, especially the respective silanes. In this method, the formation of inorganic cross-linking structures takes place; the desired, inorganic (partially) condensed products are formed mostly after initiating hydrolysis. The sol-gel step takes place generally in a suitable solvent. The product is a resin whose viscosity can be controlled by the degree of cross-linking. For lowering viscosity, for example, it can possibly be diluted even more.

Coating materials having no more than 5 mass % of solid in the solvent have proved to be well suited for the purposes of this invention in order to obtain satisfactorily dense sheathings around the particles. Lower concentrations in the range of about 0.8 to 4 mass %, and especially from 2.5 to 4 mass %, for example, are even better. If the concentration falls under 0.5 mass %, it will not be possible to ensure for all cases that a sufficiently dense coating can be applied to the particles for preventing a flame or another kind of damage. The coating thickness can be controlled via the weight of the solid mass in the coating material relative to that of the particles to be enveloped; it can make up advantageously from about 0.5 to 10, especially 0.5 to 5% of the weight of the particles to be enveloped, more preferred from 0.8 to 2%.

The selection of the solvent is not critical. Generally, it is favorable to keep as solvent for the coating process at least some times the one used for producing the respective coating material.

The coating itself should take place under inert gas, preferably under argon, since both the metal particles that contain nickel and those that do not contain nickel can be exposed to oxygen or moisture until their fully passivation.

Once the coating material is applied to the particles, most of the solvent is removed. This can be done preferably by using the rotary evaporator to carefully remove it under mild temperatures (approx. 40-70° C.). The full drying/hardening of the coating can generally be achieved with this method—because apart from the drying effects caused by the draining off of the solvent that can contribute to a continuing inorganic cross-linking, the metallic surface of the coated particles has a catalyzing effect especially on the organically cross-linkable resin groups so that it is generally not necessary to provide additional energy in the form of more intense heat or radiation and/or to add initiators or catalysts to the coating material in order to cause the organic cross-linking of the residues R in the silanes of formula (I).

The passivating effect of the coating according to the invention can be detected with thermo-gravimetric measurements. Accordingly, ground but uncoated powder samples already become unstable at 130° C. and ignite, whereas if a coating according to the invention is applied, they remain stable up to at least about 230° C. Thus, the processing of finely crystalline electrode materials is significantly facilitated as long as they are coated according to the invention.

An exothermic reaction takes place in an oxygen atmosphere as expected from the self-ignition of the pyrophoric material. The ignition is correlated with a weight gain in accordance with the oxidation of mostly nickel to NiOₓ.

In rechargeable batteries, the so-called C rate plays a crucial part in the quality of the electro-chemical properties because it indicates the magnitude of the charging and discharging currents independently from the capacity of the various cells. In tests done with cells equipped with high-performance electrode material coated according to the invention, a high discharge charge could also be detected with a high C rate—i.e. with fast discharging processes—compared to conventional electrode materials. In the course of this, the speed of the power output was even above that of uncoated micro particles.

The invention will now be described in more detail by means of examples.

### EXAMPLE 1

248 g (1 mol) of methacryloxypropyltrimethoxysilane and 355 g of diethyl carbonate are initially weighed in a 1 liter flask. 0.37 g (10 mmol) of ammonium fluoride and 27 g (1.5 mol) of distilled water are added and stirred. After several days (10 to 20), the resulting solvent is removed with the rotary evaporator at 40° C. up to 100 mbar. The material is viscous and yellowish.

### EXAMPLE 2

236 g (1 mol) of 3-glycidoxypropyl-trimethoxysilane are initially weighed with 355 g of diethyl carbonate in a 1 liter flask. 0.37 g (10 mmol) of ammonium fluoride and 27 g (1.5 mol) of distilled water are added and the mixture stirred. After several days (10 to 20), the resulting solvent is removed with the rotary evaporator at 40° C. up to 100 mbar. The material is yellowish and solid.

Example 3

246 g (1 mol) of 2-(3,4-epoxycyclohexyl) ethyltrimethoxysilane are initially weighed with 355 g of diethyl carbonate in a 1 liter flask. 0.37 g (10 mmol) of ammonium fluoride and 27 g (1.5 mol) of distilled water are added and the mixture stirred. After several days (10 to 20), the resulting solvent is removed with the rotary evaporator at 40° C. up to 100 mbar. The material is yellowish and viscous.

Example 4

24.6 g (0.04 mol) of tris(3-trimethoxysilyl)propylisocyanurate, 70 g (0.2 mol) of polyethylene glycol-monomethylester 350 and 0.48 g of 30% sodium methylate solution in methanol are initially weighed in a 250-mL flask in that order, stirred and slowly removed with the rotary evaporator at 50° C. and 100 mbar until constant weight is achieved.

Example 5

Particle-coating method and resulting properties

Standard AB₅ Varta material is used as NiMH powder either not ground or ground according to Mechanomade® method.

20.4 g of NiMH are initially weighed in a 100-mL flask under argon. According to Example 2, 0.500 g of coating material are weighed with diethyl carbonate (,-,-. 0.17 g of coating material without solvent) and 7 g of propyl acetate in a 100-mL flask. The flask is moved slowly in the argon-flushed rotary evaporator. After about 30 minutes, the removal with the rotary evaporator begins at 40° C. up to 20 mbar; afterwards, the temperature is increased to 60° C. and the removal with the rotary evaporator continues for 1 hour under these conditions.

The thermal behavior of the ground particles before and after applying the coating results in the following: Whereas the untreated powder samples become thermally unstable already at a temperature of 130° C. and ignite, the powder passivated with the coating according to the invention remains stable at least up to 230° C.

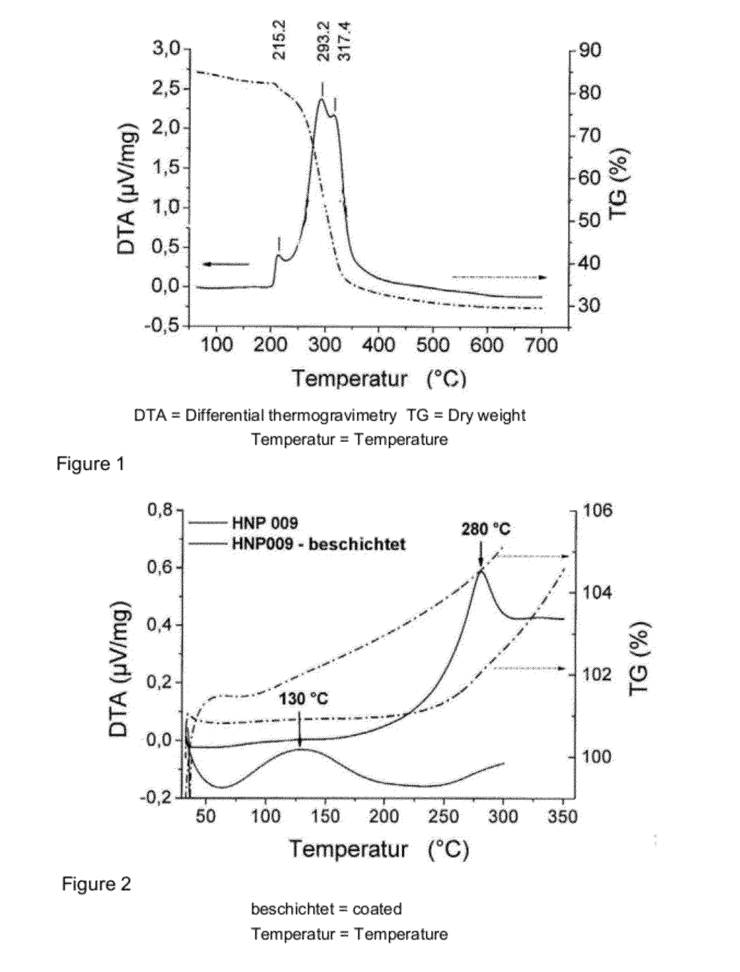

FIG. 1 shows the thermal behavior of the coating material according to Example 2. FIG. 2 shows the dry weight/differential thermogravimetry analysis of the ground NiMH powder, once for the uncoated powder and on the other hand for the same powder coated according to Example 2.

Therefore, for the uncoated material, one sees an exothermic peak at 130° C. coupled with a starting weight gain, whereas the coated material shows a weight gain that starts only at 230° C. First of all and according to FIG. 1, this is due to the starting decomposition of the passivation coating. The exothermic reaction of the metal occurs at 280° C., as can be seen in FIG. 2.

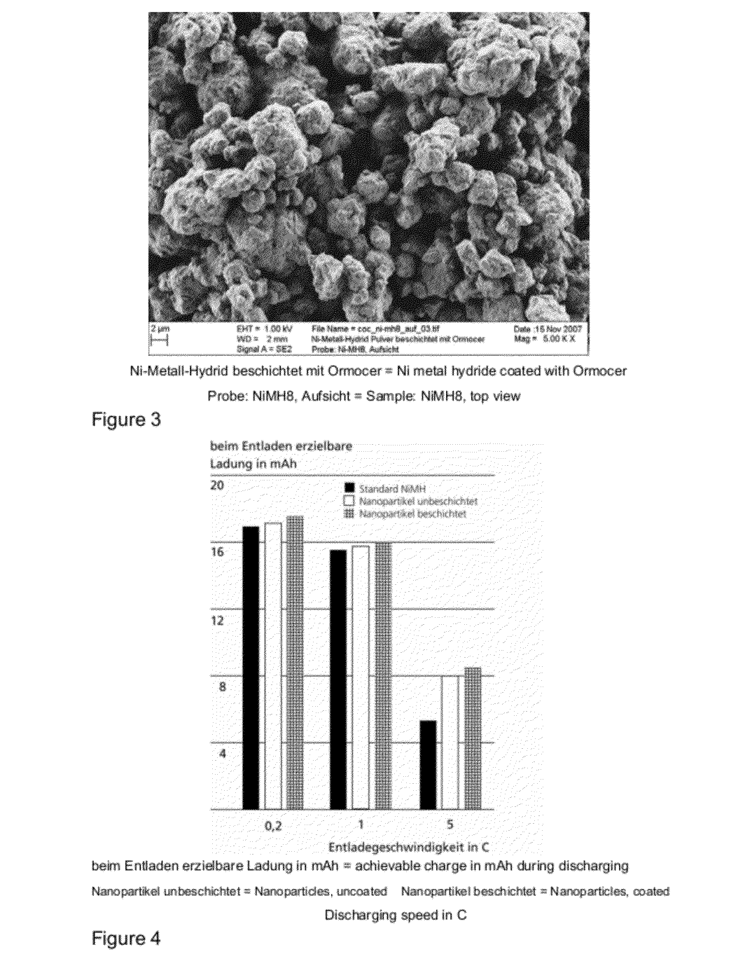

A scanning electronic microscope photograph of the powder, whose thermogravimetry can be seen in FIG. 2, is shown in FIG. 3.

### EXAMPLE 6

### Electrode Production

Electrodes were produced by mixing the coated NimH powder with nickel powder (10%) according to Example 5. From the homogenous mixture, pills were molded (25 kN/cm²) that after integration into a nickel mesh were molded to negative electrodes (5 kN/cm²). The nickel mesh is used for preventing a loosening of the electrode particle composite during cyclization (10-20% elongation of the electrodes during the charging/discharging process).

Electrodes can be produced by other processes too, such as sedimentation of the particles containing nickel or other metal hydrides from the coating solution (ORMOCER® with solvent) directly on a Ni film as current collector. Afterwards, by drying the electrodes in the oven (under protective gas), the ORMOCER® coating is organically polymerized for passivating the particles.

The molded metal hydride powder is then incorporated into standard V15H button cells (Varta) and measured.

Compared to standard NiMH batteries, it was possible to increase power output by more than 50 percent at a C rate of 5 C (discharge in ⅕ hour=12 minutes). Thus, the power output was even above that of the uncoated micro particles. The power capacity of the new reactive materials is therefore increased even more by the passivation according to the invention. FIG. 4 shows the comparison between NiMH test cells with high performance electrodes and coated, ground NiMH powder according to Example 5 and conventional cathode materials that also use AB₅ materials.

1. Powder, comprising particles with a metallic core configured to store hydrogen or comprising hydrogen in stored form, and with a coating comprising an organically modified (hetero) silicic acid polycondensate.

2. Powder according to claim 1, wherein the core comprises (a) nickel or (b) nickel or magnesium, in combination with an additional metal selected from among aluminum, lanthanum and the lanthanides, manganese, cerium, iron, cobalt, scandium, titanium, zirconium, vanadium, chrome, manganese, silicon, or a combination of said metals.

3. Powder according to claim 1, wherein the core of the particles has an average diameter of less than 15 μm.

4. Powder according to claim 1, wherein the organically modified (hetero) silicic acid polycondensate is made using, at least one silane having the formula (I)
RₐR′_{b}SiX_{4-a-b} (I)
wherein the substituents R, R′ and X can be either the same or different and wherein R represents an organically cross-linkable group R bound to silicon through carbon, R′ an organically not cross-linkable group bound to silicon through carbon, X a group that can be hydrolyzed under hydrolysis conditions or split off from silicon or is OH, a is 1 or 2, b is 0 or 1 and a+b can be 1 or 2.

5. Powder according to claim 4, wherein at least one part of the groups R has been selected from among groups containing acrylate and/or methacrylate and/or epoxy and/or isocyanurate.

6. Powder according to claim 4, wherein the organically modified (hetero) silicic acid polycondensate was made using at least one additional silane having the formula (II)
R′ₐSiX₄₋ₐ (II)
wherein R′ and X can either be the same or different and have the same meaning as in formula (I) and a is 0, 1, 2, 3 or 4, or using at least one additional silane having the formula (III)
RₐR′₃₋ₐSiX (III)
wherein R, R′ and X have the meaning given in claim 1 for formula (I) and a is 1, 2 or 3,
or using at least one organic compound of a metal of the III main group, of germanium and/or a metal of the II, III, IV, V, VI, VII and VIII subgroup.

7. Powder according to claim 4, wherein the organically modified (hetero) silicic acid polycondensate was made using at least one silane of formula (I), wherein X is an alkoxy and a+b equals 1, as well as at least one silandiol having the formula (IV)
R″₂Si(OH)₂ (IV)
wherein the group R″ can either be the same or different and is a substituted or unsubstituted alkyl group or has the same meaning as R in formula (I).

8. Powder according to claim 1, wherein the organically modified (hetero) silicic acid polycondensate has organic cross-linked groups.

9. Powder according to claim 4, wherein the organically modified (hetero) silicic acid polycondensate was created by applying a coating varnish and cross Haim it, whereby this varnish was produced with a sol-gel method.

10. Powder according to claim 1 that is molded in electrode shape.

11. NiMH battery with a negative electrode having metal particles comprising hydrogen in stored form or are configured to store hydrogen, and are embedded in a gel-shaped sheath or matrix that conducts OH⁻ ions that are formed through the action of an aqueous, alkaline electrolyte on an organically modified (hetero) silicic acid polycondensate.

12. NIMH battery according to claim 11, wherein the organically modified (hetero) silicic acid polycondensate from which the matrix is formed comprises organically cross-linked groups.

13. NIMH battery according to claim 11, wherein the wherein the organically modified (hetero) silicic acid polycondensate from which the matrix is formed is made using at least one silane having the formula (I)
RₐR′_{b}SiX_{4-a-b} (I)
wherein the substituents R, R′ and X can be either the same or different and wherein R represents an organically cross-linkable group bound to silicon through carbon, R′ an organically not cross-linkable group bound to silicon through carbon, X a group that can be hydrolyzed under hydrolysis conditions or split off from silicon or OH, a is 1 or 2, b is 0 or 1 and a+b can be 1 or 2.

14. NiMH battery according to claim 13, wherein the organically modified (hetero) silicic acid polycondensate was made using at least one additional silane having the formula (II)
R′ₐSiX₄₋ₐ (II)
wherein R′ and X can either be the same or different and have the same meaning as in formula (I) and a is 0, 1, 2, 3 or 4, or using at least one additional silane having the formula (III)
RₐR′₃₋ₐSiX (III)
wherein R, R′ and X have the meaning given in claim 1 for formula (I) and a is 1, 2 or 3,
or using at least one organic compound of a metal of the III main group, of germanium and/or a metal of the II, III, IV, V, VI, VII and VIII subgroup.

15. NiMH battery according to claim 13, wherein the organically modified (hetero) silicic acid polycondensate was made from least one silane of formula (I), wherein X is an alkoxy and a+b equals 1, as well as at least one silandiol having the formula (IV)
R″₂Si(OH)₂ (IV)
wherein the group R″ is a substituted or unsubstituted alkyl group or has the same meaning as R in formula (I).

16. Method for producing an NIMH battery according to claim 13, encompassing the steps:
(a) Production of a coating material by hydrolytic condensation of at least one silane having the formula (I)
RₐR′_{b}SiX_{4-a-b} (I)
wherein the substituents R, R′ and X can either be the same or different and R represents an organically cross-linkable group bound to silicon through carbon, R′ an organically not cross-linkable group bound to silicon through carbon, X a group that can be hydrolyzed under hydrolysis conditions or split off from silicon or is OH, a is 1 or 2, b is 0 or 1 and a+b can be 1 or 2, in a solvent,
(b) Applying of the coating material on particles having a metal core capable of storing hydrogen or containing hydrogen in stored form,
(c) Removing of at least one part of the solvent and increasing the temperature of the coated particles to 40-70° C.,
(d) Converting of the coated particles into an electrode shape, and
(e) Joining the material formed according to step (d) with the additional components of an NiMH battery.
